(19) United States
(12) Patent Application Publication
(10) Pub. No.: US 2005/0021731 A1
(43) Pub. Date: Jan. 27, 2005

(54) Traffic flow analysis method

(76) Inventors: Hannu Sehm, Helsinki (FI); Antti Pekkanen, Helsinki (FI)

Correspondence Address: NIXON PEABODY, LLP, 401 9TH STREET, NW, SUITE 900, WASHINGTON, DC, 20004-2128, US

(21) Appl. No.: 10/484,773

(22) PCT Filed: Jul. 16, 2002
(86) PCT No.: PCT/FI02/00638

(30) Foreign Application Priority Data
Jul. 24, 2001 (FI) 20011568

(51) Int. Cl. G06F 15/173

(52) U.S. Cl. 709/224; 709/217

(57) ABSTRACT

The present invention describes a method for collecting visitor information in a distributed browser-based traffic analysis system. The method comprises the steps of: receiving a request with a content server from a network element for an interpreted language page content; receiving the interpreted language page content, the interpreted language page content having at least one measurement code comprising a measurement element source attribute specifying a measurement program; receiving a request for the source data of the measurement element, the request comprising at least one data structure including at least one of at least one page ID and at least one category ID and at least one time stamp and other relevant data; comparing the content of the fields of the data structure(s) to a predefined set of rules in the measurement program; updating the counters or other programming structures in the measurement program based on the comparison; updating the data structure(s), and providing the network element with the updated data structure(s) and the source data for the measurement element.

### FIELD OF THE INVENTION

The present invention relates to website traffic monitoring. In particular, the present invention relates to a novel and improved method for monitoring, e.g. website traffic in a very efficient and accurate way.

### BACKGROUND OF THE INVENTION

The Internet can be regarded as a world-wide computer network. The growth rate of terminals connected to the Internet has been enormous. The Internet provides several different services. Among these are World Wide Web (WWW), email, File Transfer Protocol (FTP) etc. Especially the first two services are very popular.

The Internet comprises of servers and hosts which are interconnected to each other. Thus the Internet is actually a “virtual” network which is formed by an innumerable amount of “physical” networks. A user can request data files from an Internet-connected computer. The computer is usually a server which provides the user, e.g. web pages. The web pages are typically written in a mark-up language called hypertext mark-up language (HTML).

The Internet is a very attractive form of media for commercial purposes. Websites have become an important means for businesses and individuals to disseminate new product and service information. With the word website we refer to a term which includes several webpages. The maintainer of a website can monitor the pattern of web browser requests. It is clear that advertisers in different kinds of websites would like to know how many visitors are visiting the website. Therefore accurate monitoring information is a very important piece of information to different kinds of advertisers. Therefore, various software programs and monitoring services have been developed to track service requests.

Traffic monitoring is an essential part in analysing the use of the Internet. The visitor traffic information is a valuable piece of information practically in every website which tries to increase service requests or advertising benefits. Traffic monitoring is generally divided in two different methods:
server-based traffic analysis, and
browser-based traffic analysis.
   Server-Based Traffic Analysis:

Website servers can be configured to store information to a log file for every website page request they receive. The log file is then later analysed and a website traffic report is produced. The statistics in a log file can include various elements, e.g. time of day, identification of the requesting computer, referring link etc.

A proxy server is a device which can store web content, e.g. html-pages on a central location. When a website page is requested from a web browser, the request is routed through a proxy server. The proxy server checks if it has the requested html-page in its cache storage. If the page is found the proxy server sends the desired page back to the web browser. If the requested website page is not cached in the proxy server, it requests the page from the actual web server. The functionality of the proxy server forms a problem when server-based traffic analysis is used. When the proxy server finds the requested html-page in its cache the request is not recorded in the original web-server log file. However, some proxy servers can notify the web server of the requests made. The above-mentioned problem with proxy servers exists also when the requested page is found in some other cache memory, e.g. the browser cache memory. Therefore, the request is not recorded in the log file.

The server-based solution is not a problem free solution. Server-based tools do not typically provide a real-time view of the website traffic data. If the log analysis tools are installed locally on the website file server, then the website owner can only use tools that are available for the platform of the hosting file server computer. Moreover, website owners who operate very high-traffic sites often disable logging because of inadequate computer resources to operate both the file server function and the traffic logging function.

Browser-Based Traffic Analysis:

An alternative solution to the server-based traffic analysis is the browser-based traffic analysis service. The browser-based analysis typically relies on special html code inserted into the page on a website. The webpage usually consists of several different elements that may be retrieved from different locations. The location is indicated with a Uniform Resource Locator (URL).

The browser-based traffic monitoring is based on a small graphical element which is retrieved from a server that is in a different location from the primary website file server. The source location attribute directs a browser to the computers of the traffic analysis service.

It is very important to identify the website visitor. A well known technique for that is to use so called “cookies” which identify the visitor uniquely. A cookie contains information about the visitor, last visiting time, how long the cookie is valid etc.

Browser-based tools normally collect visitor information about pages which contain the special (html) code. Normally, the code has to be inserted into every page for which traffic analysis is wanted. The special code refers usually to a 1×1 pixel size invisible picture (referred to as graphical element). The web server which provides the traffic analysis is generally managed by the company providing the traffic analysis. A cookie which specifies a web browser is logically bound to the graphical element. When a website is visited the special html code (the graphical element) is also requested by the browser. At the same time certain information about the website visitor is supplied with the graphical element request. This information comprises information about, e.g. the browser used, the version of the browser, the operating system, supported programming languages, time spent on the webpage etc. The cookie is also transferred to the traffic analysis server. The cookie comprises information, e.g. about the visited path on the website, time interval between consecutive visits, how often the website is visited etc. Visitors are recognised from each other by the user ID.

The browser-based traffic analysis has many advantages over the server-based traffic analysis. The browser-based analysis results are more reliable than server-based results because webpage requests from proxy servers are included. The browser-based traffic analysis is generally real-time although some server-based solutions are almost real-time. The browser-based traffic analysis is typically an ASP-service (ASP, Application Service Provider) and thus does not waste the resources of the web file server of the client. Also, it does not require the installation of traffic measurement applications in the www server of the client when browser-based tools are used.

Reference publication WO 0075827 presents a centralised browser-based traffic analysis. All centralised browser-based traffic analysis systems have some common features. The traffic analysis server is a standalone server different from the website server. This enables a multiwebsite traffic analysis with only one traffic analysis server. The visitors of a website are identified with a cookie. If the use of a cookie is disabled, the visitor should not be included in the traffic monitoring. It is measured that only a fraction (less than two percents) of web browsers are configured to reject cookies. The traffic monitoring information is transferred to the traffic analysis server where it is analysed, stored and reported to the customer.

The browser-based traffic analysis method/system enables versatile and extensive production of measurement information. As much as a hundred different quantities can be reported. At the same time, however, there are only few really important main quantities. The main quantities are, e.g. page hits, visits, unique visitors, time spent on a webpage and time spent on a website. The reporting interval is, e.g. a day, a week or a month.

Although browser-based traffic analysis and other traffic analysis systems produce an innumerable amount of traffic analysis data they have certain problems and weaknesses:
A centralised traffic measurement system requires a significant data transfer bandwidth and data processing capacity. Some traffic analysis companies have hundreds of servers which can process several billion graphical element requests per day. The amount of servers causes large financial investments and maintenance costs. The costs are transferred to the customer prices which can easily be as much as $10000/month/large website.
A large traffic measurement data storage and processing capacity in practise requires a centralised measurement solution. The customers are not willing to install database and software solutions for browser-based traffic analysis systems in their own web servers because the enormous amount of information requires capacity and maintenance.
In a centralised traffic measurement system graphical elements are often requested from a server different from the website file server. This weakens the accuracy of the measurement result and may expose the website functionality to errors. If the data communication connection between the graphical element and the measurement server is down the download process of the requested website page may take quite a while. In the worst case part of the website page may remain unloaded or the user may receive an error message of the fact that the connection to the measurement server is down.
Some part of the measured quantities require so much storage space that it is not reasonable to measure those quantities. E.g. unique visitors are measured and reported only by website basis. Webpage-based measurement results would be very essential in order to understand website traffic. However, the collection of this kind of information with present means would require excessive data storage on popular and large websites.

There are centralised browser-based solutions where the traffic analysis program resides in the same web file server as the normal website content. However, in the view of data storage these systems are considered as centralised solutions. The present systems record the traffic monitoring data in a centralised file or similar data storage, which is like a log file. The analysis of the file is then processed within one or more batch runs. Especially the measurability of the key quantities related to different visitors is directly dependent on the amount of the collected and stored information. It follows that on a popular website traffic monitoring methods require a large data storage. From the data storage and analysis perspective these systems are comparable with the server-based measurement systems described in the reference publication WO 0075827.

### SUMMARY OF THE INVENTION

The present invention concerns a method, a measurement server system and a program product for collecting visitor information in a distributed browser-based traffic analysis system by means of tracking data requests for the retrieval of mark-up language pages. In the present invention, a content server receives a request from a network element for an interpreted language page content. The content server sends the interpreted language page content to the network element, the interpreted language page content having at least one measurement code comprising a measurement element source attribute specifying directly or indirectly a measurement program. The measurement program then receives a request from the network element for the source data of the measurement element, the request comprising also one or more data structuredata structures and other relevant data. The fields of the data structuredata structure(s) are compared to a predefined set of rules in the measurement program. The information element is preferably a cookie. Based on the comparison, the counters or other programming structures are updated in the measurement program. The measurement program updates the data structure(s) and provides the network element with the updated data structure(s) and the source data for the measurement element. In one embodiment of the present invention, extra features and new measurement subjects are added to the measurement program.

The present invention describes a distributed browser-based traffic analysis system where the information needed is distributed into the data structure(s). The data structure is in a preferred embodiment a cookie that is normally located in the hard disk of a computer. The analysis of the traffic information is performed with the measurement program. The resources required in the analysis, however, are nominal and the analysis is executed in real time. The measurement program is typically installed in the www server because the installation and the traffic measurement do not necessarily need a standalone server nor extensive data storage systems.

An important feature in the invention is that the information required in the traffic analysis is stored on the data structures, e.g. cookies. In a preferred embodiment of the invention, there are two cookies. Therefore the measurement program does not need a large storage with which different visitors are separated. In the present measurement systems, the users are equipped with a unique user ID. In the present invention, unique user Ids are not needed because the measurement program reads only cookies that are set from the domain(s) of the website. Therefore, the cookies are unique for each website and for each visitor. If there is, e.g. a setting “Only accept cookies originating from the same server as the page being viewed” enabled in the browser, then no cookies are sent to a measurement server in a different domain. Therefore, a measurement server located in a different domain is not capable of measuring reliably website traffic when the above mentioned setting is enabled.

Due to the present invention, the reliability of the measurement increases because in the acquirement of the measurement element, the same data communication connection is used as in the acquirement of the website content. Thus, the data connection to the measurement program is identical and as fast and reliable as the data connection to the website content.

The traffic measurement described in the invention can be implemented at a lower price than in centralised browser-based traffic analysis systems because there is no need to buy or arrange a separate data connection to the measurement server in order to obtain the measurement element. Also the traffic measurement can be implemented at a lower price than in the centralised browser-based traffic analysis systems because for the analysis of the traffic there is no need to maintain a database with which the visitors are identified. Also the processing required in the analysis is performed with the website server of the customer. The required processing, however, is nominal and therefore in practise does not load the website server of the customer very much. The load of the measurement element requests is usually directed to the same server(s) as the other website requests and not to a separate traffic measurement server that might serve several different websites.

An important feature of the present invention is that the pricing of the traffic measurement can be independent of the amount of the traffic. When the amount of the information flow increases, the extra burden is directed to the existing website server(s).

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a network over which requests for data files are processed in accordance with the present invention,

FIG. 2 is a graphical representation of the data flow over the network of FIG. 1,

FIG. 3 is a block diagram showing the construction of a combined www server and measurement server of FIG. 1,

FIG. 4 is a flow diagram illustrating the processing steps executed by a browser of FIG. 1 to perform the operations in accordance with the present invention,

FIG. 5 is a flow diagram illustrating the processing steps executed by the measurement server of FIG. 1,

FIG. 6 is an exemplary webpage cookie format passed back and forth between the browser and the measurement server of FIG. 1, and

FIG. 7 is an exemplary website cookie format passed back and forth between the browser and the measurement server of FIG. 1.

### DETAILED DESCRIPTION OF THE INVENTION

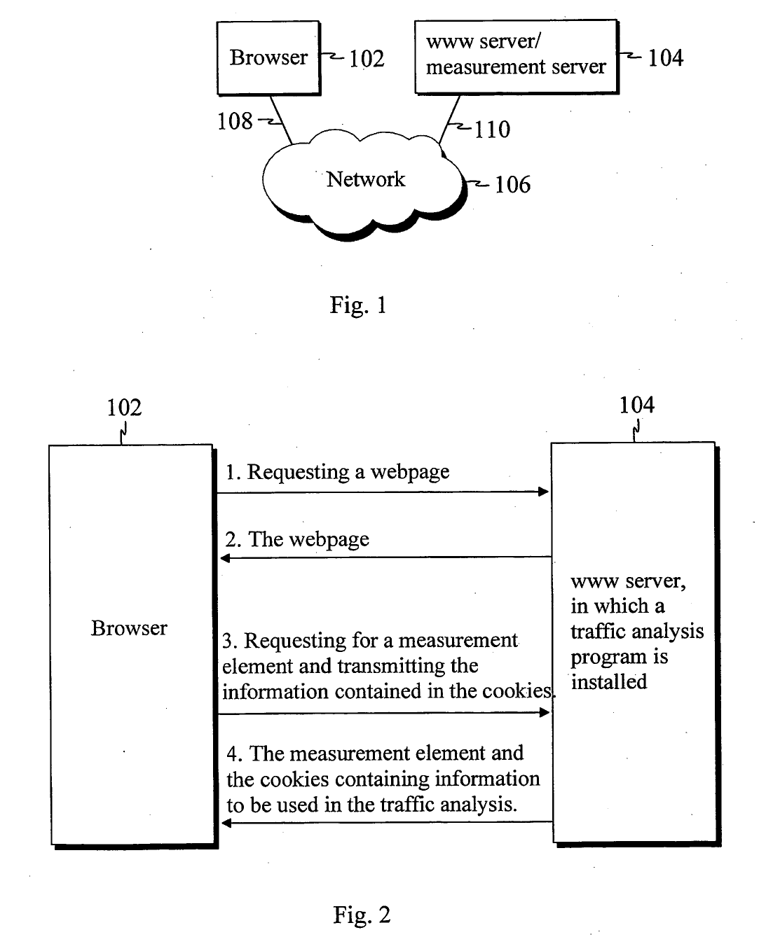

FIG. 1 is a representation of a system that provides Internet website traffic analysis in accordance with the present invention. An Internet user at computer 102 having a graphical user interface (GUI) browser program gains access to Internet content to be delivered from www server 104 by requesting, e.g. hypertext mark-up language (html) documents at the www server 104. Data relating to such webpage and website visits is automatically collected in the measurement server 104. User requests for website pages and exchange of traffic analysis data takes place over network connections that can include connections that are collectively referred to as the Internet 106. Thus, the user 102 is connected to the Internet 106 via a network connection line 108 that may be a conventional telephone line or a high-speed access line. Similarly, the www server/measurement server 104 is connected to the Internet 106 via a connection 110. It is clear that the Internet content server 104 may comprise multiple file servers on which website files are stored.

FIG. 2 is a graphical representation of the data flow over the Internet between the browser 102 and the www server/measurement server 104 illustrated in FIG. 1. Those skilled in the art understand that a cookie is a data structure written to a browser computer, e.g. upon an initial visit to an Internet website in response to server-side processing. Thereafter, when the browser again requests a page from a website, the browser will automatically provide the stored cookie along with the request for a page. Those skilled in the art understand that a measurement element with a source attribute, such as an image source file, java applet, frame, iframe, layer, ilayer, vbscript or javascript source, must be specified by the location of the measurement element file, which the browser will request when it attempts to display the web page and executes a code.

In accordance with the invention, a request for a website page that has been marked or tagged with the appropriate mark-up language code includes a measurement code specifying the measurement element source located at the measurement server. A website cookie and a webpage cookie are initially produced by the measurement program arranged in the measurement server and the cookies are returned to the browser computer with the measurement element source file. The cookie is, however, only one example of possible data structures that can be used in the present invention. Cookies can also be encoded or compressed in order to save space. The browser stores the cookies on the browser computer in accordance with the conventional browser operation. The remaining website page elements, such as text and other images, are preferably provided by the www server.

Thus, FIG. 2 shows a request for a measurement element source file being made to the measurement server substantially at the same time that the request for the website page is being made to the www server. FIG. 2 also shows that the measurement element source file and the cookies are returned by the measurement server computer 104.

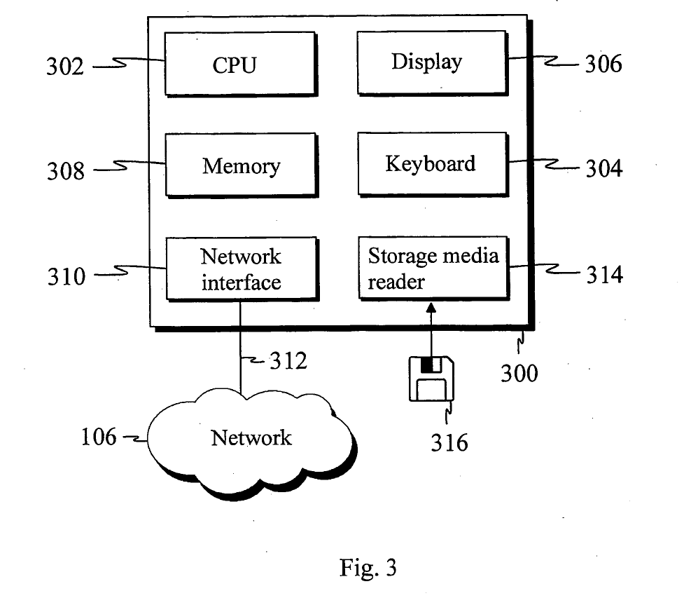

FIG. 3 is a block diagram of an exemplary computer 300 such as might comprise the www server and the measurement server 104. The computer 300 operates under the control of a central processor unit (CPU) 302, such as a Pentium microprocessor and associated integrated circuit chips, available from Intel Corporation. The user can input commands and data from a keyboard 304 and can view inputs and computer outputs on a display 306. The display 306 is typically a video monitor or a flat panel display. The CPU 302 operates under the control of programming steps that are stored, temporarily, on a memory 308 of the computer 300. The computer 300 communicates with the Internet 106 through a network interface 310 that enables the communication over a connection 312 between the Internet 106 and the computer 300. The computer 300 can also receive computer instructions, or data, from a storage media reader 314. The storage media reader 314 receives storage media 316 from which it can read stored information. That is, the storage can contain program steps that are executed by the CPU 302 to perform a method for providing Internet access, as described above. The storage media 316 thereby comprise a program product embodying the program steps executed by the CPU 302. Examples of storage media 316 include floppy disks and CD-ROM media.

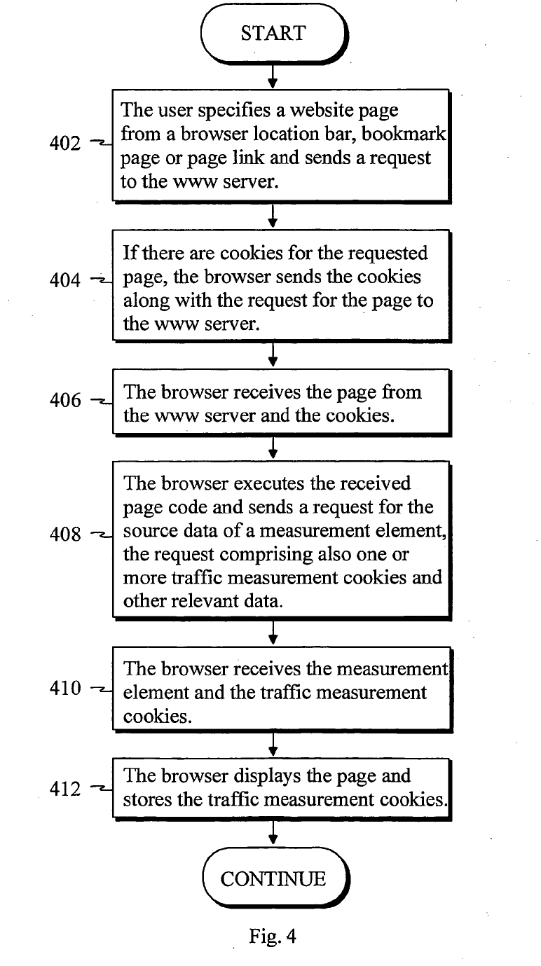

The processing of the html code will be better understood with the reference to the flow diagram of FIG. 4, which illustrates the processing steps executed by a browser 102 of FIG. 1 to perform operations in accordance with the present invention.

At the first programming step, represented by FIG. 4, flow diagram box numbered 402, the user requests a website page from a browser location bar, page link, from another webpage or bookmark. When a browser is first launched, the browser identifies the websites and webpages for which it has cookies. Thereafter, if the user directs the browser to one of the identified websites, the browser automatically provides the cookies with its request for a page from the website. Those skilled in the art understand that a website is identified by having a common URL domain on which other html document pages are stored on a hierarchical file structure.

The flow diagram box 404 illustrates the next browser processing step where the browser determines if there are conventional cookies for the requested page and, if so, sends the corresponding cookies along with the request for the page. After some processing by the www server, the browser receives the requested html website page and also the returned cookies, as indicated by the flow diagram box numbered 406. The flow diagram box 408 illustrates the next processing step where the browser executes the received website page code. The page includes also a measurement code comprising a source attribute for a measurement element, the source attribute specifying directly or indirectly a measurement program. Indirectly means that the attribute refers to, e.g. a proxy server that directs the request to the measurement server. In response to the execution of the html page code, the browser sends a request for the source data of the measurement element to the measurement program. The request comprises also one or more traffic measurement cookies and other relevant data.

With the measurement code it is possible to find out certain information about the visitor, such as the operating system, the browser version etc. This information refers to above mentioned other relevant data. The browser receives the requested measurement element and the traffic measurement cookies from the measurement program directly or indirectly, as indicated by the flow diagram box numbered 410. Finally, as represented by the flow diagram box numbered 412, the browser displays the appropriate html code and the measurement element source, and stores the received cookies, just as it would any other website cookie it received. Browser operation then continues. Thus, implementation of web traffic measurement by cookie updating and exchanging in accordance with the invention is completely transparent to the browsers of the website visitors.

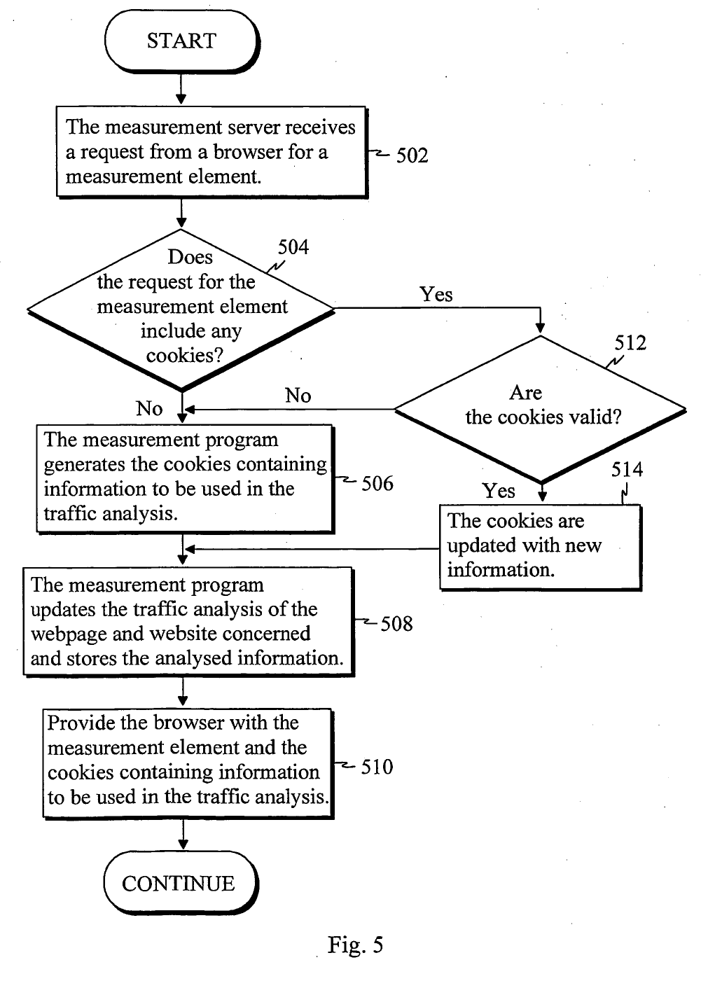

FIG. 5 is a flow diagram that illustrates the processing steps executed by a measurement program arranged in the measurement server 104 illustrated in FIG. 1. At the first processing step, represented by the flow diagram box numbered 502, the measurement program receives a request from a user browser for a measurement element. The measurement program then determines if the request includes any cookies, as indicated by the decision box numbered 504.

If the request has no cookies, a negative outcome in the box 504, then the measurement program generates the cookies (a website cookie and a webpage cookie) to be used in the traffic analysis. This action is presented by the flow diagram box numbered 506. If the request did contain the cookies, an affirmative outcome in the decision box numbered 504, then the measurement program next checks to see whether the cookies are valid. The checking step is represented by the decision box numbered 512. The integrity of a cookie is confirmed with the check sum field of the cookie. If the check sum computed is equal to the check sum in the cookie, the cookie is valid. If the cookies are not valid, the cookies are somehow damaged, a negative outcome in the box 512.

In the preferred embodiment of the invention, there are two cookies—a website and a webpage cookie. However, it is also possible to use only one cookie by combining the information of the two cookies into one cookie. If the cookies are valid, an affirmative outcome in the decision box numbered 512, the measurement program updates the cookies (the website cookie and the webpage cookie) with new information, as indicated by the flow diagram box numbered 514. Actually, new cookies are generated when previous cookies are observed to be obsolete.

The measurement program updates the traffic analysis information of the website and the webpage concerned and stores the analysed information, as indicated by the flow diagram box numbered 508. The counter data or the programming structure data in which the traffic analysis information is accumulated can be reported in a desired moment with a built-in reporting application directly to the customer. There are also other possibilities to report the traffic analysis data. The counter data or the programming structure data in which the traffic analysis information is accumulated can be transferred from the measurement program to the party providing the traffic measurement service. Then the traffic analysis information is reported in a desired moment to the customer owning the content server containing the interpreted language pages. The traffic analysis information can also be reported to a desired party other than the customer.

Finally, the measurement program provides the browser with the measurement element source and the cookies containing information to be used in the traffic analysis, as indicated by the flow diagram box numbered 510.

In a preferred embodiment of the invention, the measurement program is in the same domain as the website content. However, the measurement program does not have to be in the same domain. The measured website, e.g. comprises of the domains www.company.com and search.company.com. The measurement program can be located in a server in the domain traffic.company.com. All the domains can be in the same server or in separate servers. However, one measurement program can be used with the traffic measurement of different websites. In such a case, for each measured website there has to be a domain or a virtual domain in the measurement server.

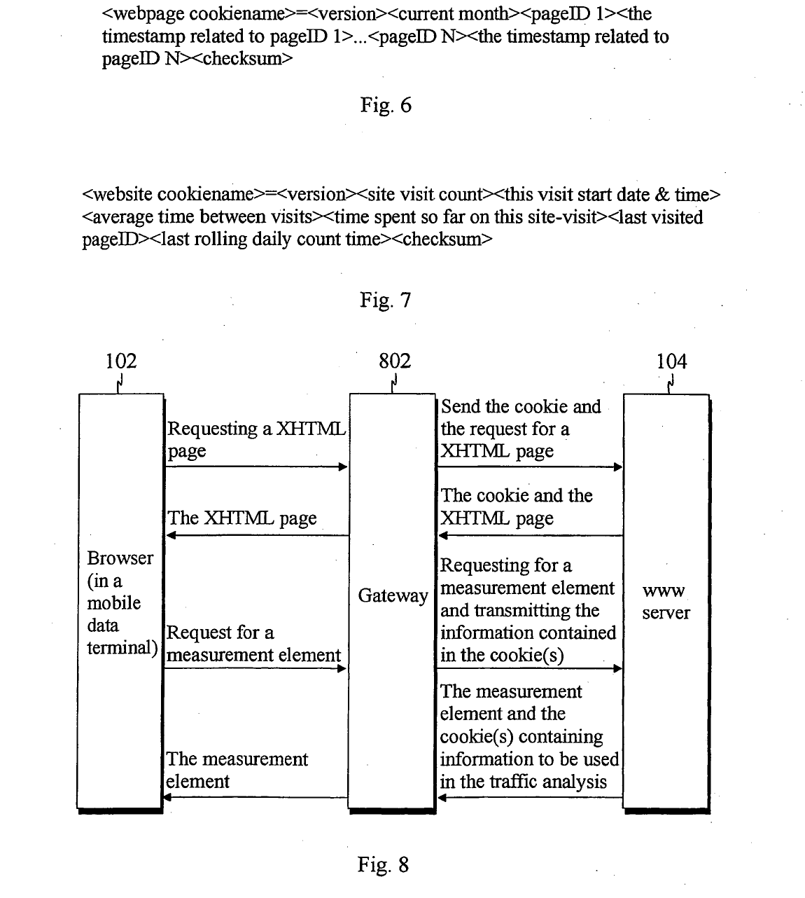

FIG. 6 is an exemplary webpage cookie format, such as will be passed back and forth between the browser and the measurement server to track traffic, as shown in the present invention. The cookie begins with the cookie name and version. Next, “current month” refers to a month to which other timestamp fields in the webpage cookie are compared. The timestamp is expressed in seconds after the beginning of the month. The value in this field is determined in proportion to the “current month” field. So, e.g. 320 seconds means actually “current month” plus 320 seconds. “PageID” is a field that determines a certain page that is tracked. PageID is a unique identifier to each page to be monitored. Next is a timestamp field relating to a certain pageID. In other words, each page ID relate to a certain timestamp field. The pageID and the corresponding timestamp field are very essential fields in the present invention. The last field is always a checksum with which the integrity of the cookie is ensured.

FIG. 7 is an exemplary website cookie format, such as will be passed back and forth between the browser and the measurement server to track traffic, as shown in the present invention. The cookie begins with the cookie name. The next field of the cookie is the site visit count field. This field contains a number showing the visits on the website. Next, “this visit start date and time” is used, e.g. in updating the “time spent so far on this site-visit” field. The average time between visits is computed using a predetermined algorithm.

One example of a possible algorithm will now be described. The most recent timestamp is searched from the webpage cookie. If the time interval between the current time and said timestamp is more than 30 minutes, the visit is regarded as a new visit. Then, the time between the visits is calculated by subtracting the most recent timestamp from the current time. The new value for average time between site-visits field is computed, e.g. by emphasizing the old value by 9/10 and the calculated value by 1/10, and it is stored on the website cookie.

The “Time spent so far on this site-visit” field contains a number determining the duration of the present visit in seconds. The last visited pageID refers to a pageID which identifies the most recent page visited. If the time interval between the content of the “last rolling daily count time” field and current time is more than 24 hours, the visitor is regarded as a “Rolling Daily Uniques” visitor. It means that additional visitor information is also stored, e.g. the browser used, the operation system used, support for cookies etc. The last field is again a checksum with which the integrity of the cookie is ensured.

An important part of the invention are the counters located in the measurement server. The functionality relating to the counters will now be described. The prior-art solutions offer at their best tens or even hundreds of different visitor statistics. However, the drawback with the prior art solutions is that the amount of the information is enormous and the analysis of the information consumes the processing capacity. The problem is solved in the present invention in a way that the visitor statistics are gathered with simple counters. Every counter describes a quantity that can be used in a traffic analysis. The updating procedure of the counters is based on a predefined set of rules, i.e. conditional statements. If the conditional statement(s) is/are not realised, the value of a certain counter is not increased. There are several measurable quantities, and every counter related to a certain quantity has its own conditional statements. Next, a few counter examples are presented.

Page View: It is not required any information of the cookies to count page views made. Every request increases the page view counter by one. There is one exception in which case the counter is not incremented: the reload procedure.

Reload: When the cookies are received from the browser and less than 15 seconds has elapsed since the previous visit to the same webpage, the reload counter is incremented by one. The page view counter is not incremented.

Visits: The most recent timestamp is searched from the webpage cookie. If more than 30 minutes has elapsed compared to the time in the cookie, the webpage visit counter is incremented by one. This quantity can also be reported by different categories. The categories include first visit, 2-5 visits, 6-10 visits etc. The counters are cumulative, so the same user is included in the first visit counter in the first visit. When the user visits the website again, he/she is again included in the 2-5 visits counter etc.

Average time between visits: The most recent timestamp is searched from the webpage cookie. If the time interval between current time and said timestamp is more than 30 minutes, the visit is regarded as a new visit. Then, the time between the visits is calculated by subtracting the most recent timestamp from the current time. The new value for average time between site-visits field is computed, e.g. by emphasizing the old value by 9/10 and the calculated value by 1/10 and stored on the website cookie.

Most of the counters are incremented by one when needed. However, there are some counters that may be incremented by a number else than one. The number is determined by a predetermined algorithm. An example of this kind of counters are mean time counters. Some counters may also be decremented in certain situations. The duration of a visit may be reported using different categories. The categories include durations of 1-5 seconds, 6-20 seconds, 21-60 seconds etc. The first page visit does not increment the counter. When the visitor makes another page request, the “This visit start date and time” field is read from the website cookie. The duration of the present visit is calculated and the counter related to the calculated duration (e.g. 1-5 seconds) is incremented by one. When the visitor again makes a request for a new page after 10 seconds from the previous request, the duration of the visit belongs to the 6-20 seconds category. Therefore, the 1-5 seconds counter is decremented by one and the 6-20 seconds counter is incremented by one.

The pageID identifier in the webpage cookie is normally comprehended as identifying only the page. However, one website may sometimes comprise hundreds of webpages. Therefore, it is not always reasonable to report page visits separately page by page. Similar pages can be grouped into categories. In addition to reporting website and webpage related results, category-based reporting may be done. The categories include, e.g. “Movies” which comprise the pages for different movies, e.g. Blues Brothers, Piano and ET. A category may comprise one or more subcategories, e.g. “Movies/Classics/ . . . ”. One page may be included in one or more categories at the same time. With the aid of the previous examples, a webpage under a category “Movies/Classics/ . . . ” is included also in the category “Movies”.

The measurement program is always provided with the category information with the measurement element. The meaning of the pageID identifier in the webpage cookie is expanded to include also the category information. The pageID then identifies either a page or a page category. When a measurement element is requested, the measurement server is provided with a pageID and a timestamp identifying the page. If the above-mentioned categories are used, the measurement server is provided also with necessary pageID and timestamp pairs identifying one or more categories.

In a preferred embodiment of the invention, extra features and new measurement features are added to the measurement program. In this way, changes to the measurement program can be made afterwards.

In a preferred embodiment of the invention, the language used is a mark-up language. However, those skilled in the art understand that instead of a mark-up language any other interpreted language can be used. Although the detailed description is explained with html based definitions and names, the corresponding functionality is valid also in other mark-up language environments, e.g. extended Mark-up Language (XML), Wireless Mark-up Language (WML), Extensible Hypertext Markup Language (XHTML) or Compact Hypertext Mark-up Language (cHTML).

The detailed description is explained mainly with an Internet-based technique. However, the present invention is valid also in other environments, such as DigiTV and mobile telecommunications systems. The present invention is valid in any environment where interpreted language and certain data structure, e.g. a cookie, is used. In one embodiment of the invention, the functionality of the www server and the measurement program is combined so that the www server is able to handle also data structures, e.g. measurement cookies along with the interpreted language page content requests. In one embodiment, a browser sends a request for data content (e.g. html page) and the possible measurement cookie(s) to the www server. The www server executes the measurement program functionality itself. Alternatively, the measurement functionality is executed by a separate measurement program under the control of the www server. The www server updates the measurement cookie(s) and sends the data content and the measurement cookie(s) to the browser.

FIG. 8 is a graphical representation of the data flow between the browser 102, the gateway 802 and the www server 104 in a mobile telecommunication environment. FIG. 8 represents an exemplary mobile environment comprising a browser 102 arranged in a mobile data terminal, a gateway server 802 and a www server 104 containing the data content. The content is usually in the form of a mark-up language, e.g. XHTML, WML of cHTML. The content can comprise of several different elements, such as text and pictures, each of which may be requested from different locations.

The www server comprises the data content that can be presented with the mobile data terminal. The data content may be in the form of single files or it can be produced with a specific program. In order to perform the measurement functionality, a measurement program can be arranged in the www server.

The gateway 802 converts the content from the www server 104 to the form suitable for the browser of the mobile data terminal. Usually, the gateway 802 also compresses the content in order to save space before sending the content to the browser 102. The www server 104 may send identification information to the browser, e.g. a cookie, along with the data content. The information contained in the cookie is preferably stored to the gateway 802 and is not sent to the browser 102. In the request for data content, the gateway sends the possible cookie relating to the request to the www server 104 and stores the cookie returned from the www server 104. In this way, the limited memory space of the mobile data terminal does not have to be used as a cookie storage. The storage and the handling of the cookie(s) is performed by the gateway 802.

The mobile data terminal is, e.g. a mobile phone or a Personal Digital Assistant (PDA). The mobile data terminal comprises a browser program with which data content for the mobile data terminal can be requested from the Internet.

As presented in FIG. 8, the browser 102 sends a request to the gateway 802. The gateway 802 checks if it has a cookie for the requested page in its memory. If a cookie is found, the gateway 802 sends the cookie along with the page request to the www server 104. The www server 104 receives the page request and the cookie relating to the page request and returns the requested data content and the possible cookie to the gateway 802. The gateway 802 compresses the data content and sends the compressed data to the browser 102. The cookie is stored to the gateway 802 if present.

The data content received with the browser 102 comprises a measurement code ordering the browser 102 to send a request for a measurement element. The browser 102 sends the request for the measurement element to the gateway 802. The gateway 802 searches the measurement cookie for that particular measurement element, and sends a request for the measurement element and the information in the measurement cookie to the measurement program running in the www server 104. The measurement program updates the counters or other programming structures in the measurement program based on the comparison of the fields of the measurement cookie to a predefined set of rules in the measurement program. The measurement program returns measurement element source data and the updated measurement cookie to the gateway 802. Finally, the gateway 802 stores the information of the measurement cookies and sends the measurement element source data to the browser 102.

The invention is not restricted merely to the examples of its embodiments, instead many variations are possible within the scope of the inventive idea.

1. A method for collecting visitor information in a distributed browser-based traffic analysis system, wherein the information needed in the traffic analysis is stored on at least one data structures, wherein the method comprises the steps of:
a) receiving a request with a content server from a network element for an interpreted language page content;
b) receiving the interpreted language page content from the content server with the network element, the interpreted language page content having at least one measurement code comprising a measurement element source attribute specifying directly or indirectly a measurement program;
c) receiving a request from the network element with the measurement program for the source data of the measurement element, the request comprising also at least one data structures including at least one of at least one page ID and at least one category ID and at least one time stamp and other relevant data;
d) comparing the content of the fields of the at least one data structure to a predefined set of rules in the measurement program;
e) updating the counters or other programming structures in the measurement program based on the comparison;
f) updating the at least one data structure, and
g) providing the network element with the updated data structure(s) and the source data for the measurement element directly or indirectly.

2. The method according to claim 1, wherein the data structure is a cookie.

3. The method according to claim 1, wherein before step d):
detecting if the request includes at least two data structures; and
generating at least a first data structure and a second data structure in response to detecting the absence of the data structures wherein the first data structure is a website cookie and the second data structure is a webpage cookie.

4. The method according to claim 1, wherein the at least one data structures comprises a first data structure and a second data structure wherein:
the first data structure is a website cookie; and
the second data structure is a webpage cookie.

5. (Delete)

6. The method according to claim 1, wherein the updating of the at least one data structure comprises the steps of:
replacing the relevant fields with new information computed by the measurement program; and
deleting obsolete information.

7. The method according to claim 1, wherein the information in the at least one data structure is encoded or compressed in order to save space.

8. The method according to claim 1, wherein the measurement program is arranged in a measurement server being a standalone server.

9. The method according to claim 1, wherein the measurement program is arranged in a measurement server being the same server as the content server containing the interpreted language pages.

10. The method according to claim 7, wherein the measurement program is arranged in the same domain as the content server containing the interpreted language pages.

11. The method according to claim 7, wherein the measurement program is arranged in a different domain as the content server containing the interpreted language pages.

12. The method according to claim 1, wherein the counter data or the programming structure data is reported with a built-in reporting application.

13. The method according to claim 1, wherein the counter data or the programming structure data is transferred from the measurement program in order to be reported.

14. The method according to claim 11, wherein the counter data or the programming structure data is reported to a desired party.

15. The method according to claim 11, wherein extra features and new measurement features are added to the measurement program.

16. The method according to claim 1, wherein the interpreted language is any mark-up language.

17. The method according to claim 1, wherein the measurement element is any element having a source attribute.

18. The method according to claim 1, wherein the at least one data structure is sent to the network element along with the interpreted language page content.

19. The method according to claim 1, wherein the network element is a browser or a server.

20. A measurement server system for collecting visitor information in a distributed browser-based traffic analysis system by means of tracking data requests for retrieval of interpreted language pages, the measurement server system comprising at least one measurement server, wherein the measurement server system comprises at least:
one central processing unit for establishing a communication with the network; and
one program memory for storing programming instructions executed by a central processing unit in such a way that the measurement server establishes a communication with the network and communicates with a network element in such a way that the measurement server system receives a request from the network element for the source data of a measurement element, the request comprising also at least one data structures including at least one of at least one page ID and at least one category ID and at least one time stamp and other relevant data; compares the content of the fields of the at least one data structure to a predefined set of rules; updates the counters or other programming structure based on the comparison; updates the data structure, and provides the network element with the updated data structure and the source data for the measurement element directly or indirectly.

21. The measurement server system according to claim 20, wherein the at least one data structure is a cookie.

22. The measurement server system according to claim 20, wherein before the comparison the measurement server system:
detects if the request includes at least two data structures; and
generates at least a first data structure and a second data structure in response to detecting the absence of the data structures, wherein the first data structure is a website cookie and the second data structure is a webpage cookie.

23. The measurement server system according to claim 20, wherein the at least one data structure comprises a first data structure and a second data structure wherein:
the first data structure is a website cookie; and
the second data structure is a webpage cookie.

24. (Delete)

25. The measurement server system according to claim 20, wherein the updating of the at least one data structure comprises the steps of:
replacing the relevant fields with new information computed by the measurement program stored on the program memory; and
deleting obsolete information.

26. The measurement server system according to claim 20, wherein information in the at least one data structure is encoded or compressed in order to save space.

27. The measurement server system according to claim 20, wherein the at least one measurement servers are standalone servers.

28. The measurement server system according to claim 19, wherein the measurement program is arranged in a measurement server being the same server as the content server containing the interpreted language pages.

29. The measurement server system according to claim 27, wherein the measurement program is arranged in the same domain as the content server containing the interpreted language pages.

30. The measurement server system according to claim 27, wherein the measurement program is arranged in a different domain as the content server containing the interpreted language pages.

31. The measurement server system according to claim 20, wherein the counter data or the programming structure data is reported with a built-in reporting application.

32. The measurement server system according to claim 20, wherein the counter data or the programming structure data is transferred from the measurement program stored on the program memory in order to be reported.

33. The measurement server system according to claim 31, wherein the counter data or the programming structure data is reported to a desired party.

34. The measurement server system according to claim 20, wherein extra features and new measurement subjects are added to the measurement program.

35. The measurement server system according to claim 20, wherein the interpreted language is any mark-up language.

36. The measurement server system according to claim 20, wherein the measurement element is any element having a source attribute.

37. The measurement server system according to claim 20, wherein the at least one data structure is sent to the network element along with the interpreted language page content.

38. The measurement server system according to claim 20, wherein the network element is a browser or a server.

39. A program product for use in a measurement server that executes the program steps recorded in a computer-readable medium to perform a method for collecting visitor information in a distributed browser-based traffic analysis system, wherein the program product comprises:
a recordable medium; and
a program of computer-readable instructions executable by the measurement server to perform the method comprising the steps of:
a) receiving a request from a network element for the source data of the measurement element, the request comprising also at least one data structures including at least one of at least one page ID and/or at least one category ID and at least one time stamp and other relevant data;
b) comparing the content of the fields of the at least one data structure to a predefined set of rules in the measurement program;
c) updating the counters or other programming structures in the measurement program based on the comparison;
d) updating the at least one data structure, and
e) providing the network element with the updated data structure and the source data for the measurement element directly or indirectly.

40. The program product according to claim 39, wherein the at least one data structure is a cookie.

41. The program product according to claim 39, wherein before step b):
detecting if the request includes at least two data structures; and
generating at least a first data structure and a second data structure in response to detecting the absence of the data structures, wherein the first data structure is a website cookie and the second data structure is a webpage cookie.

42. The program product according to claim 39, wherein the cookies comprise a first data structure and a second data structure wherein:
the first data structure is a website cookie; and
the second data structure is a webpage cookie.

43. (Delete)

44. The program product according to claim 39, wherein the updating of the at least one data structure comprises the steps of:
replacing the relevant fields with new information computed by the measurement program; and
deleting obsolete information.

45. The program product according to claim 39, wherein information in the at least one data structure is encoded or compressed in order to save space.

46. The program product according to claim 39, wherein the measurement program is arranged in a measurement server being a standalone server.

47. The program product according to claim 39, wherein the measurement program is arranged in a measurement server being the same server as the content server containing the interpreted language pages.

48. The program product according to claim 46, wherein the measurement program is arranged in the same domain as the content server containing the interpreted language pages.

49. The program product according to claim 46, wherein the measurement program is arranged in a different domain as the content server containing the interpreted language pages.

50. The program product according to claim 39, wherein the counter data or the programming structure data is reported with a built-in reporting application.

51. The program product according to claim 39, wherein the counter data or the programming structure data is transferred from the measurement program in order to be reported.

52. The program product according to claim 50, wherein the counter data or the programming structure data is reported to a desired party.

53. The program product according to claim 39, wherein extra features and new measurement subjects are added to the measurement program.

54. The program product according to claim 39, wherein the interpreted language is any mark-up language.

55. The program product according to claim 39, wherein the measurement element is any element having a source attribute.

56. The program product according to claim 39, wherein the at least one data structure is sent to the network element along with the interpreted language page content.

57. The program product according to claim 39, wherein the network element is a browser or a server.
